(19) United States
(12) Patent Application Publication
(10) Pub. No.: US 2008/0169744 A1
(43) Pub. Date: Jul. 17, 2008

(54) Support Clips For Electric Lamp Having Strapless For Mh Arc Tubes

(75) Inventors: Mary E. Fortuna, Canisteo, NY (US); Mark W. Fellows, Hommondsport, NY (US); William T. Solsky, Bath, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILLIPS ELECTRONICS N.V., EINDHOVEN (NL)

(21) Appl. No.: 10/561,999

(22) PCT Filed: Jun. 26, 2004
(86) PCT No.: PCT/IB04/51018

§ 371 Date: Dec. 23, 2005

Related U.S. Application Data
(60) Provisional application No. 60/483,770, filed on Jun. 30, 2003.

(51) Int. Cl. H01J 61/00

(52) U.S. Cl. 313/238

(57) ABSTRACT

A medium wattage (>175 W to 400 W) metal halide electric lamp is provided having a strapless mount structure for the light source capsule while reliably passing standard drop tests. The strapless mount structure includes a support clip attached at one end to the lower end of the arc tube press and at a second end to the stem wire or to a frame portion connected to the stem wire or to a portion of the main frame.

The invention relates to electric lamps having light source capsules with generally planar seals, and more particularly, to medium wattage (≧175 W to 400 W) metal halide lamps with improved support mount for light source capsules, and such lamps having improved performance.

Electric lamps which have a light source capsule with a generally planar seal(s) include, among others, high intensity discharge (HID) metal halide and mercury vapor lamps. The light source capsule in these lamps is a discharge vessel of fused silica (quartz glass) which typically is sealed at both ends by a press seal which includes two major, substantially parallel faces and two minor, side faces extending between the major faces. Conductive lead-throughs extend through the press seal in a gas-tight manner to a pair of discharge electrodes arranged within the discharge vessel.

These lamps typically have an outer envelope which is sealed at one end by a lamp stem. A frame consisting of metallic support rods extends from the lamp stem and supports the discharge vessel within the outer envelope. Metallic support straps secured about the press seals are welded to a support rod on one or both sides of the press seal to secure the discharge vessel to the frame.

The pressing of hot fused silica produces significant variations in the resulting press seals in both width and thickness during high speed lamp manufacture. These dimensional variations present difficulties in achieving satisfactory strap designs. Many of the designs require hand fitting and adjusting of the straps on each discharge vessel during assembly of the frame to achieve a discharge vessel mount which is sufficiently rigid to pass the pre-shipment 30″ drop test criteria which is common in the industry.

The discharge vessel or arc tube is considered as the ‘heart’ of the quartz metal halide lamp because it generates light with a characteristic spectral energy distribution. Many lamp designers focus on the discharge arc tube in lamp designs and lamp diagnostics. However, the lamp outer bulb and processing, such as exhaust quality, gas fill pressure, cleanliness of metal parts, mount structure, effectiveness of getters, and photoelectrons generated from electric-conductive metal parts have significant influences on lamp performance, especially on lumen maintenance, voltage rise, and color shift.

One of the major factors affecting lamp performance is sodium diffusion through the fused quartz wall. This phenomenon decreases the sodium part of the chemical filling and thus changes the spectral energy intensity and distributions. Significant sodium loss will result in a considerable color shift, excessive lamp voltage rise, and fast lumen depreciation. Excessively high lamp voltage may cause a lamp to cycle out and lead to early failure. Moreover, sodium loss leads to a constricted arc and unstable operating characteristics. Sodium diffusion is accelerated by the presence of negative space charges on the outer surface of the discharge vessel. The negative space charges occur if ultraviolet radiation from the discharge strikes current carrying metal components within the lamp, which causes the production of photoelectrons. In such lamps it is desirable to cover exposed metal parts with a material impervious to ultraviolet radiation and having a high photoelectric work function, for example, as disclosed in U.S. Pat. Nos. 3,484,637 (Van Boort et al.) and 4,866,328 (Ramaiah et al). Van Boort et al illustrates a lamp mount that is greatly simplified. However, it is doubtful that anyone can make a discharge vessel without discharge tube ends as illustrated. In any event, such a lamp would not be expected to survive lamp handling and processing and would not reliably pass a standard drop test that is customary in lamp manufacturing.

Another approach is to reduce the amount of metal in close proximity and in direct view of the discharge vessel, as in Ramaiah et al discussed above and U.S. Pat. No. 3,424,935 (Gungle) which eliminates the elongate support rod extending adjacent the discharge vessel. However, the Gungle lamp still has a significant amount of metal parts since it includes two axially extending support rods connected to each of the support straps. Since ultraviolet radiation from the discharge vessel is also reflected off the inner surface of the outer envelope, these metal parts are still a source of a significant amount of photoelectrons.

U.S. Pat. No. 5,339,001 of King et al and assigned to a related company of the present assignee, describes and claims a metal halide lamp that includes a light source capsule having a generally planar seal having two major, substantially parallel faces and two minor faces extending therebetween, and a metallic support rod extending adjacent a minor face of the seal. A support strap for holding the seal comprises a stiffly resilient strip of metal having two spaced and opposing major leg portions each extending in contact with a respective major seal face, an elastically deformable jaw portion the major of which is not in contact with a said seal face, and end portions fixed to each other adjacent one of said minor seal faces. The elastically deformable portion is arranged such that with the end portions closed together, the deformable portion is elastically deformed and firmly biases said support strap against at least one of (a) both of said major seal faces and (b) both of said minor seal faces, for holding said seal there between. Such a strap design, minimizes the amount of metal in the frame structure (the photoelectron emission and thus the depletion of sodium from the discharge vessel being correspondingly reduced) while providing a frame which can reliably pass a standard drop test. Such a lamp, however, still contains metal straps and a field wire and these metal parts are still a source of photoelectrons that negatively impact the photoelectric properties of the lamp.

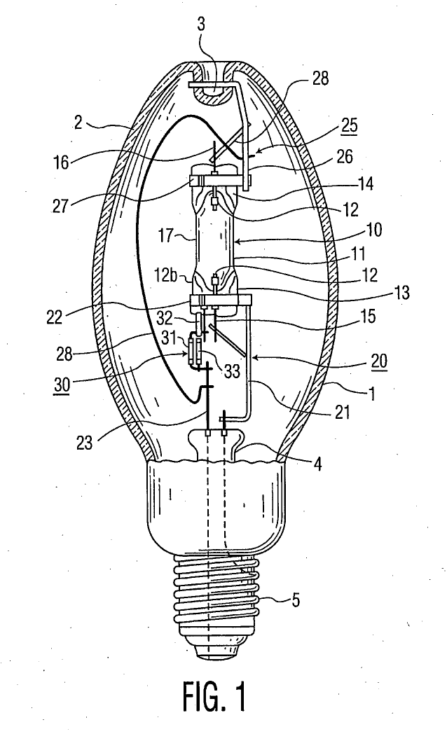

Ramaiah et al referred to above illustrates a low wattage lamp (≦150 W) that does not use support straps. This is not surprising in view of the small size and light weight of the discharge tube. In the U.S. market, lamp manufacturers do not use metal support straps in low wattage lamps because of the light weight of the discharge tube, but all lamp manufacturers use metal support straps in medium wattage and high wattage metal halide lamps that have a discharge vessel similar to that shown in FIG. 1.

There is a need in the art for a medium wattage metal halide lamp that reduces electric carrying metal parts to slow sodium diffusion. There is also a need in the art for a medium wattage metal halide lamp that exhibits improved performance without the use of metal straps.

This invention is an improvement in said lamps with a strapless mount as described and claimed in said copending application wherein the ability of such lamps to resist lateral, centrifugal, and longitudinal motion is enhanced.

It therefore is an object of the invention to provide medium wattage (≧175 W to 400 W) electric lamps that comprise a strapless mount structure wherein the ability of such lamps to resist lateral, centrifugal, and longitudinal motion is enhanced.

A further object of the invention is to provide such an enhanced mount structure, within the outer envelope of lamps having a power of about ≧175 W to about 400 W, and an alkali-halide containing discharge vessel that reduces sodium diffusion and improves lamp performance over life as compared to electric lamps that comprise a mount structure with straps and a frame wire as presently used in the lighting industry.

These and other aspects of the invention are more fully described with reference to the following drawings and detailed description.

FIG. 1 illustrates a metal halide lamp having a discharge vessel sealed at each end by planar press seals and secured to a support frame by a respective support strap and having a field wire according to the prior art;

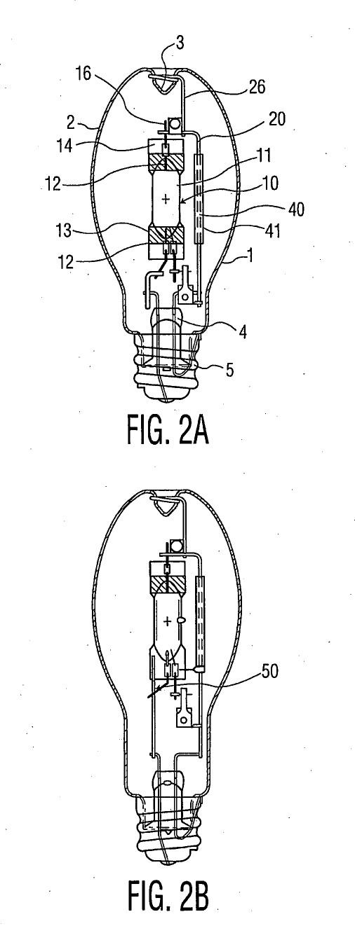

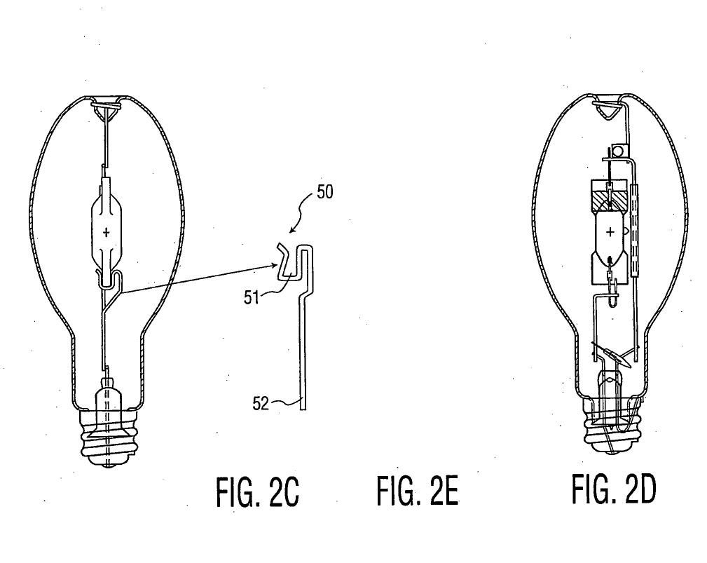

FIG. 2a illustrates a metal halide lamp having a discharge vessel sealed at each end by planar press seals and secured to a support frame by a strapless mount structure;

FIG. 2b illustrates the metal halide lamp of FIG. 2a and comprising a frame structure with a vertical clip according to one embodiment of the present invention;

FIG. 2c is a schematic illustrating one embodiment of a wire connector or clip illustrated in FIG. 2b;

FIG. 2d is a schematic illustrating another embodiment of a wire connector or clip illustrated in FIGS. 2a and 2b;

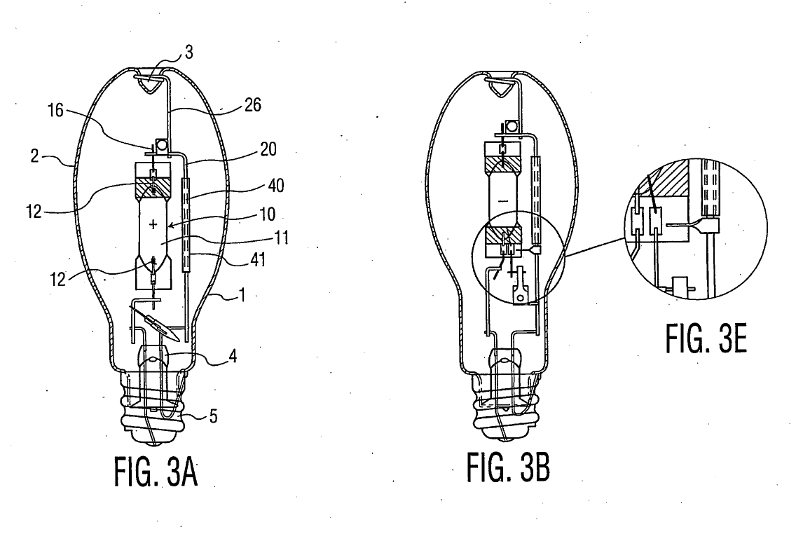

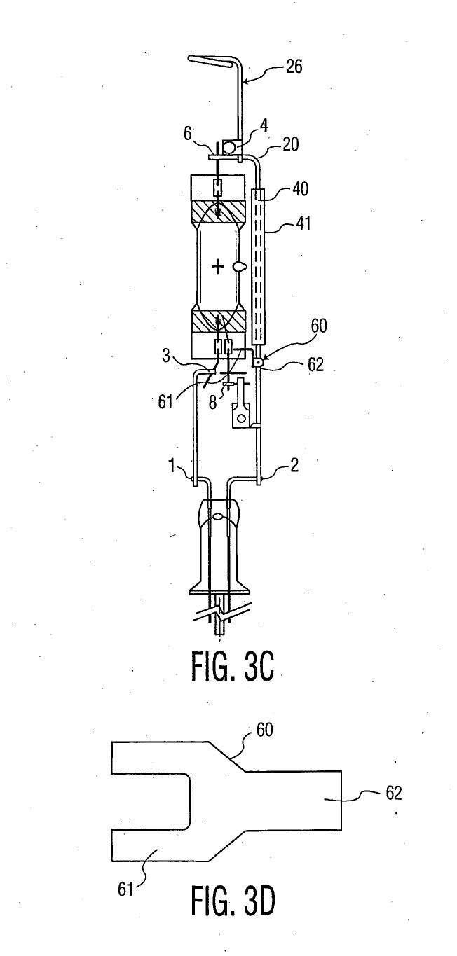

FIG. 3a illustrates a metal halide lamp having a discharge vessel sealed at each end by planar press seals and secured to a support frame by a strapless mount structure;

FIG. 3b illustrates the metal halide lamp of FIG. 3a and comprising a frame structure with a horizontal clip according to one embodiment of the present invention;

FIG. 3c is a schematic illustrating one embodiment of a wire connector or clip illustrated in FIG. 3b;

FIG. 3d is a schematic illustrating one embodiment of a wire connector or clip illustrated in FIGS. 3b and 3c;

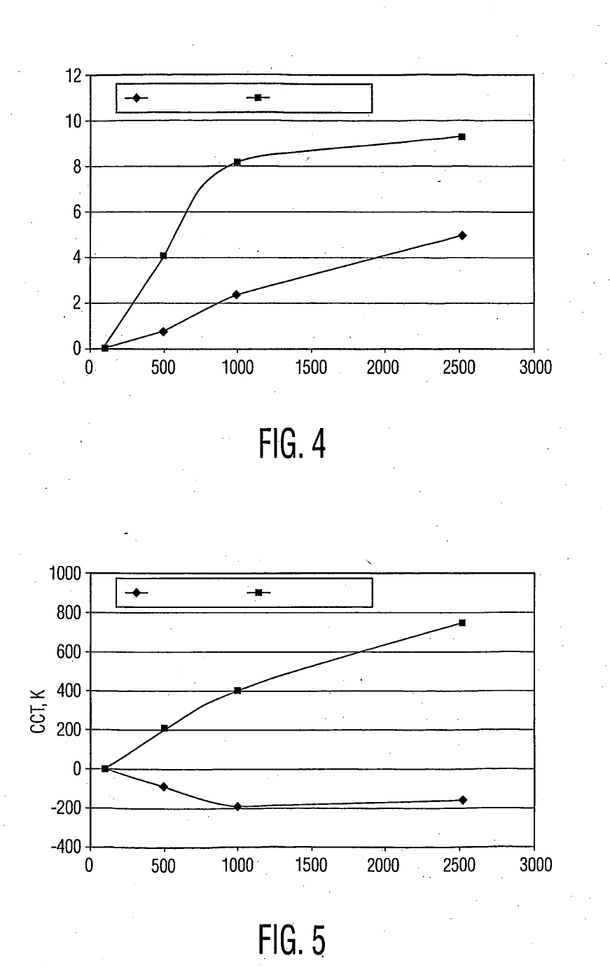

FIG. 4 is a graph that illustrates lamp voltage rise properties of lamps with strapless mount structure according to said copending application compared to lamps secured to a support frame by a respective support strap and having a field wire according to the prior art;

FIG. 5 is a graph that illustrates 1 color shift properties of lamps with strapless mount structure according to said copending application compared to lamps secured to a support frame by a respective support strap and having a field wire according to the prior art;

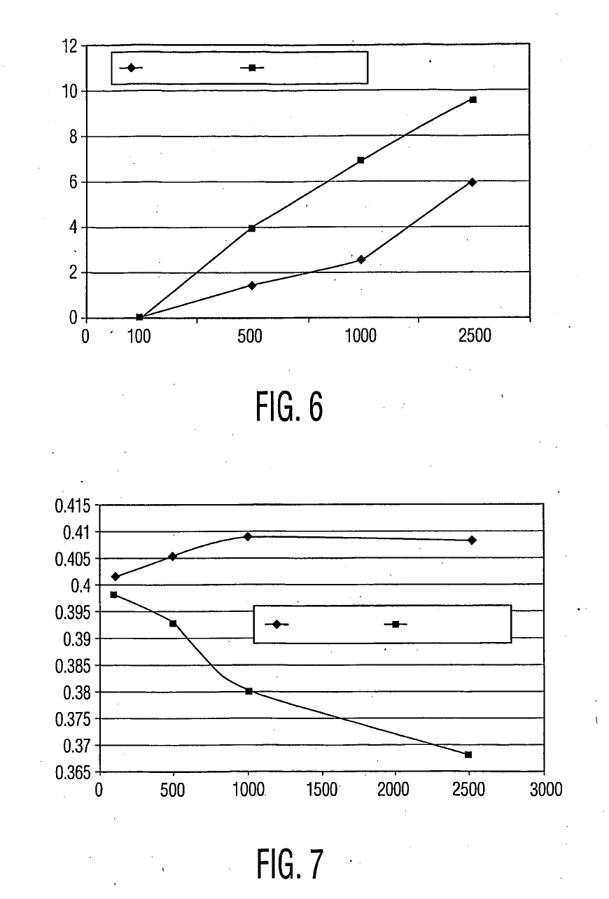

FIG. 6 is a graph that illustrates CRI properties of lamps with strapless mount structure according to the present invention compared to lamps secured to a support frame by a respective support strap and having a field wire according to the prior art;

FIG. 7 is a graph that illustrates X coordinate properties of lamps with strapless mount structure according to the present invention compared to lamps secured to a support frame by a respective support strap and having a field wire according to the prior art;

FIG. 8 is a graph that illustrates color shift properties of lamps with strapless mount structure according to the present invention compared to lamps secured to a support frame by a respective support strap and having a field wire according to the prior art;

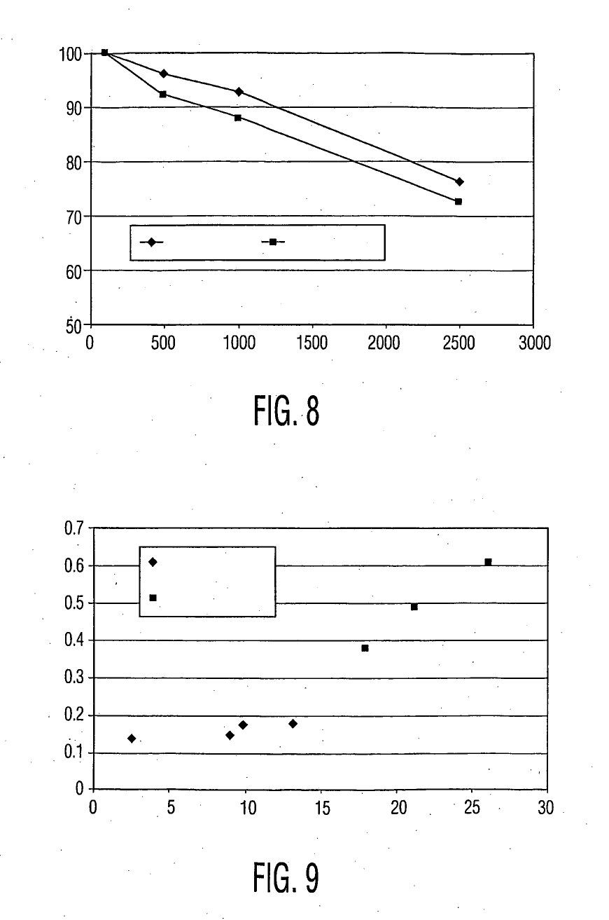

FIG. 9 is a graph that illustrates lamp voltage rise versus iodine pressure in lamps with strapless mount structure according to the present invention compared to lamps secured to a support frame by a respective support strap and having a field wire according to the prior art;

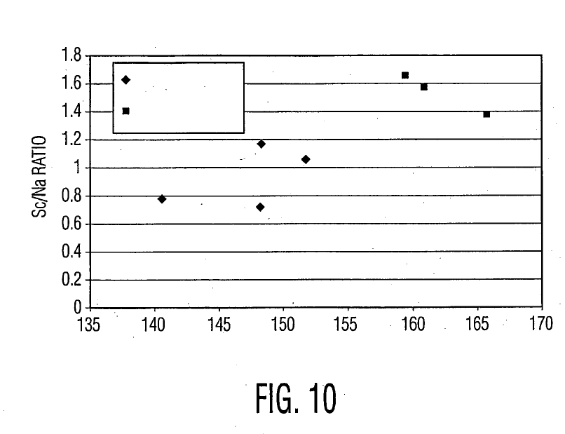

FIG. 10 is a graph that illustrates lamp voltage rise versus the Sc/Na emission ratio in lamps with strapless mount structure according to the present invention compared to lamps secured to a support frame by a respective support strap and having a field wire according to the prior art;

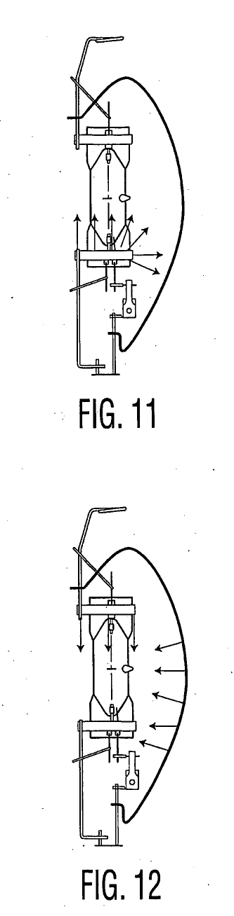

FIG. 11 illustrates the photoelectron emission in a lamp, secured to a support frame by a respective support strap and having a field wire according to the prior art, when the lower strap is negative; and

FIG. 12 illustrates the photoelectron emission in a lamp, secured to a support frame by a respective support strap and having a field wire according to the prior art, when the field wire is negative.

FIG. 1 shows a metal halide (HID) lamp having a power of ≧175 W to 400 W, an outer lamp envelope 1 with a dome portion 2 which includes an inwardly extending dimple 3. A conventional lamp stem 4 seals the base end of the outer envelope in a gas-tight manner. A conventional screw base 5 is arranged on the envelope. Arranged within the envelope is a light source capsule 10 comprised of a conventional discharge vessel 11 of fused silica (quartz) glass which encloses a discharge space and in which a pair of discharge electrodes 12 are arranged at opposite ends of the discharge space. The ends of the discharge vessel are sealed by generally planar press seals 13, 14 through which electrically conductive lead-throughs 15, 16 extend to the discharge electrodes in a gas-tight manner. The discharge vessel includes a conventional discharge sustaining filling of mercury, a rare gas, and one or more metal alkali-halides, such as a sodium halide, scandium halide, and lithium halide.

The discharge vessel is supported within the outer envelope by a frame consisting of first and second frame sections 20, 25. The first frame section 20 extends from the lamp stem 4 and includes a metallic support rod 21 extending adjacent a minor face of the press seal 13 facing the stem. The second frame section 25 includes a support rod 26 contacting the dimple 3 at the dome end of the lamp envelope and extending axially adjacent a minor face of the other press seal 14. Metallic support straps 22, 27 extend about each press seal and are welded to respective ones of the support rods 21, 26. The electrodes 12 are connected to respective contacts on the base 5 by a conventional field wire 28 connected to current conductor 23 and conductive support rod 26, which is connected to lead-through 16 by conductive wire 29, and by conductive wire 24 connecting the conductive support rod 21 to lead-through 15. The auxiliary, starting electrode 12b is connected to current-conductor 23 through starting circuit 30 which consists of an insulative bridge 31, bimetal 32 and resistor 33. This starting circuit is more fully described in U.S. Pat. No. 5,079,480 (Canale et al.), herein incorporated by reference.

The strap is readily secured on the press seal by welding end portions to the respective support rod 21 or 26. Since the support rods 21, 26 do not extend along the body 17 of the discharge vessel, there are no current-carrying metal parts in direct view of the discharge.

Frames of this type are known, for example from the above-mentioned Canale U.S. Pat. No. 5,079,480 and King et al U.S. Pat. No. 5,339,001.

FIG. 1 illustrates an example of the lamp structure with the discharge vessel supported within the outer envelope by a frame consisting of first and second frame sections 20 and 25. The first frame section 20 extends from the lamp stem 4 and includes a metallic support rod 21 extending adjacent a minor face of the press seal 13 facing the stem. The second frame section 25 includes a support rod 26 contacting the dimple 3 at the dome end of the lamp envelope and extending axially adjacent a minor face of the other press seal 14. Metallic support straps 22, 27 extend about each press seal and are welded to respective ones of the support rods 21, 26, such structure with two metal straps 22, 27 being representative of one that has been widely used in the lighting industry for decades. The purpose of these two metal straps around the arc tube is to secure the arc tube in its position. Because the two metal straps are electrically charged when the lamp is in operation, they can emit photoelectrons and negatively affect sodium diffusion for metal halide lamps. Moreover, the two straps are so close to the discharge vessel that the photoelectrons from the straps are much easier to reach the vessel surface than the other electric carrying metal parts inside the outer envelope.

A lamp mount structure without metal straps according to the invention, the so-called ‘strapless structure’ for medium wattage (≧175 W to 400 W) metal halide lamps of the invention has been assembled. FIGS. 2a and 3a illustrate two examples of the structure for switch-start and pulse-start lamps, respectively. The structures are similar to that described above in FIG. 1 and the same numbering is used where the same parts are involved. It is to be noted, however, that several metal parts and their corresponding welds are eliminated in lamps of the present invention while the lamps still reliably pass a standard drop test. For example one or more of straps 22, 27 and the field wire 28 are eliminated, and the main frame 20 is of a different configuration. Because the frame 20 has the same electric connection function as the field wire used in FIG. 1, the field wire is no longer necessary in the strapless structure. No metal contacts the arc tube in these structures. As illustrated in FIGS. 2a and 3a, a metal halide (HID) lamp of the invention is illustrated having an outer lamp envelope 1 with a dome portion 2 which includes an inwardly extending dimple 3. A conventional lamp stem 4 seals the base end of the outer envelope in a gas-tight manner. A conventional screw base 5 is arranged on the envelope. Arranged within the envelope is a light source capsule 10 comprised of a conventional discharge vessel 11 of fused silica (quartz) glass which encloses a discharge space and in which a pair of discharge electrodes 12 are arranged at opposite ends of the discharge space. The ends of the discharge vessel are sealed by generally planar press seals 13, 14 through which electrically conductive lead-throughs 15, 16 extend to the discharge electrodes in a gas-tight manner. The discharge vessel includes a conventional discharge sustaining filling of mercury, a rare gas, and two or more metal alkali-halides, such as a sodium halide and scandium halide.

The discharge vessel is supported within the outer envelope by a main frame 20 which extends from a metallic support rod 26, which contacts the dimple 3 at the dome end of the lamp envelope. The main frame 20 extends axially adjacent a minor face of the other press seal 14, to a metallic support rod 21, which extends from the lamp stem 4. An auxiliary starting electrode 12b is connected to the main frame 20 through an integrated starting circuit 30 that consists of an insulative bridge, bimetal and resistor. One of the electrodes 12 is connected to the main frame 20 through lead-through 16. The other frame section 27 includes a current conductor 27 that connects to the electrode 12 by lead-through 15. This frame section 27 is connected to the base 5 through a current-conductor 23.

A pulse-start metal halide lamp with strapless structure is shown in FIG. 3a, which is very similar to the switch-start metal halide lamp illustrated in FIG. 2. The only difference for the pulse-start lamp is the use of an ultraviolet enhancer 28 instead of a starting circuit 30 and auxiliary starting electrode 12b. The ultraviolet enhancer 28 that provides a starting aid connects to the frame 27.

An insulator sleeve 41 may cover at least a portion of the main frame 40. The sleeve may be either quartz or ceramic. Preferably, it is a quartz sleeve 41 and is effective for blocking photoelectrons produced from the portion of the main frame 40 and to prevent such photoelectrons reaching the arc tube surface. Another purpose for the insulator sleeve 41 is to block ultraviolet radiation from the discharge vessel to reach the main frame 20. Such sleeves per se are known in the art, for example, U.S. Pat. No. 3,780,331 to Knochel.

FIGS. 2b, 2c, 2d, 3b, 3c, and 3d, each illustrate an embodiment for an improvement in the strapless mount through the use of a clip 50, 60 for stabilizing the arc tube on the main frame. With reference to FIGS. 2b and 2c, there is illustrated a vertical support clip 50 which at one end 51 is welded to the arc tube lead to electrically charge the arc tube and firmly restrains the arc tube 10 from lateral, centrifugal, and longitudinal motion. The clip at a second end 52 is attached to the stem wire. The clip is at the same electrical potential as the adjacent electrode 12. FIG. 2d illustrates another embodiment of a vertical support clip wherein one end is welded to the arc tube lead to electrically charge the arc tube and at another end is welded to a frame portion connected to the stem wire.

With reference to FIGS. 3b, 3c, and 3d, there is illustrated a horizontal clip 60 which at one end 61 slides over the arc tube press 13 and firmly restrains the arc tube from lateral, centrifugal, and longitudinal motion. The clip at a second end 62 welds to the side frame.

In addition, the vertical clip illustrated in FIGS. 2a and 2b can also be used as a horizontal clip. In this case, the clip would snap over a portion of the arc tube press at one end, and be welded to the side frame and would not be electrically charged.

### Experiments

### Accelerated Life Tests

Na diffusion through fused quartz by electrolysis is well known. The mechanism of the the sodium migration is that the photoelectrons emitted from the mount metal parts (frames, field wire, straps, etc) deposit on the arc tube surface and produce a negative potential. It is this negative potential that attracts the positive sodium ions Na⁺ and subsequently accelerates sodium migration through the arc tube wall. A gas filled envelope is used in most metal halide lamps to reduce the mean free path of the photoelectrons and retard the photoelectrons from reaching the surface of the arc tube. Based on this mechanism, a vacuum filled envelope, in which the mean free path of the photoelectrons increases, can serve as an accelerated life test for metal halide lamps, especially for tests on sodium loss, color shift, and voltage rise.

Three types of metal halide lamps including two switch-start MH400/U and MH250/U lamps, and one pulse-start MS400/BU/PS lamp as illustrated in FIGS. 2 and 3, respectively, and a lamp as illustrated in FIG. 1, were built into two mount structures and sealed in a vacuum envelope. The chemical system for these lamps is sodium-scandium. Five lamps of each group were made and tested.

At 100 hours, there were essentially no differences between these two mount structures in lamp photometric properties. However, a difference was seen at as early as 500 hours. These results are illustrated in FIG. 4. At 2,500 hours, the MH400/U lamps with the strapless structure show less than half of the voltage rise compared to that of the lamps with two metal straps. Two lamps with metal straps were cycling, with one at 1,660 hours and the other at 2,518 hours, due to high lamp voltage.

Color shift at 2,500 hours is more than three times larger for the lamps with two metal straps compared to that of the strapless structure. FIG. 5 demonstrates the difference in the accelerated life test.

When significant sodium loss takes place in a metal halide lamp, the ratio of the scandium and sodium contribution in the spectral distributions will increase. CRI (“CRI” stands for “color rendering index”) will increase accordingly due to the increased scandium portion in distributions and broad scandium emissions in the visible range. FIG. 6 plots the CRI shift up to 2,500 hours. The lamp with the strapless structure has less CRI shift than that of lamps with straps.

X coordinate shift in the CIE chromaticity system is another parameter that is related to sodium loss in metal halide lamps. A decrease in the x coordinate over the lamp life may be an indication of sodium loss. The tests recorded in FIG. 7 illustrate that lamps having a mount structure with metal straps have a significant x coordinate shift up to 2,500 hours.

Lamp lumen maintenance in a vacuum envelope for two structures is presented in FIG. 8. The lamps with the strapless structure have better lumen maintenance than that of the lamps with straps.

Two other lamp tests on MH250/U and MS400/BU/PS lamps show similar trends. The lamps with the strapless structure have less voltage rise, better lumen maintenance, and less color shift than the lamps with two straps.

### Spectroscopic Analysis

A spectroscopic analysis was performed on MH400/U lamps with a vacuum envelope. A Jarrell-Ash one-meter spectrometer equipped with an Oriel silicon photodiode detector was used for emission spectrum measurements. The emission was read with a Keithly model 480 picoammeter and the signal was recorded on HP7015B X-Y recorder. Several mercury emission lines in different ranges were used as wavelength calibrators.

Three spectroscopic measurements were conducted: delta lambda sodium Δλ (the reversal maximum of sodium resonance line emission contours around 589.0 nm), the scandium emission at 625.0 nm and sodium emission at 616.1 nm, and the iodine emission at 973.2 nm and mercury emission at 1014.0 nm. An infrared filter was used when the iodine and mercury emissions in the infrared range were measured. Delta lambda sodium is closely correlated to the sodium vapor pressure, the ratio of the scandium and sodium emissions are related to the salt ratio between scandium and sodium, and the ratio of the iodine and mercury emissions in infrared is correlated to the iodine pressure in the arc tube. Because sodium is dosed into an arc tube as sodium iodide, sodium loss will leave iodine behind and cause the iodine pressure to increase.

Table 1 presents the spectroscopic analysis results for two mount structures in a vacuum envelope. All seven test lamps were burned for 6,000 hours.

TABLE 1
Spectroscopic analysis results for two mount structures.
The standard deviation is in parentheses.

| | | Delta-lambda | | |
|---|---|---|---|---|
| Lamp mount | Lamp N | Na, Å | Ratio of Sc/Na | Ratio of I/Hg |
| Strapless | 4 | 20.3 (2.2) | 0.93 (0.22) | 0.16 (0.02) |
| With straps | 3 | 16.2 (0.8) | 1.54 (0.14) | 0.49 (0.11) |

The spectroscopic analysis demonstrates that the strapless structure has less sodium loss, higher delta-lambda sodium, lower scandium and sodium emission ratio, and lower iodine pressure in the arc tube at 6,000 hours.

It was observed with interest that the lamp voltage rise was closely related to iodine pressure, as seen in FIG. 9. That is, the higher the iodine pressure, the faster the lamp voltage rise. It was also found that the lamp voltage rise was related to the ratio between the scandium and sodium emissions as illustrated in FIG. 10.

Wet Chemical Analysis

A wet chemical analysis was performed for MH4001U lamps with a vacuum envelope. The salt was dissolved in heated water and dilute hydrazinium hydroxide solution. Concentrated nitric acid was added into the solution. Total sodium in the arc tube was determined with a flame atomic absorption spectrometer (flame-AAS) using an air-acetylene flame at a wavelength of 589.0 nm. Total scandium was analyzed by means of Inductively Coupled Plasma—Atomic Emission Spectrometer (ICP-AES) at wavelengths of 361.383 mm and 357.253 nm. The samples were measured using a calibration with the same acid concentration as the samples and with known sodium concentrations. The lamps analyzed were burned for 6,000 hours.

The wet chemical analysis revealed that, at 6,000 hours, two lamps with the strapless structure had sodium loss of 10.7% and 14.7%, as compared to 21.9 and 27.9% loss for two lamps with straps. The molar ratio of sodium and scandium was 22.5 and 25.1 for the strapless structure, and 16.3 and 19.9 for the lamps with straps, as compared to a ratio of 35 originally dosed into the arc tubes. It was found that the more the sodium loss, the higher the voltage rise. These results are consistent with the life tests and spectroscopic analysis detailed above.

Life Test in a Nitrogen Filled Envelope

Several types of metal halide lamps with two mount structures in a nitrogen filled envelope were life tested. They include phosphor coated MH175/U lamps, pulse-start MS320/U/PS and MS400/BU/PS lamps, and switch-start MH250/U and MH400/U lamps. The test results consistently showed that the strapless structure has less voltage rise, better lumen maintenance, and less color shift over lamp life. Up to 5,000 hours, based on the test data, these lamp types with the strapless structure demonstrated 5% to 12% better lumen maintenance than the lamps with straps.

The mechanism of sodium loss was described by Waymouth et al. in “Sodium loss processes in metal halide arc lamps”, IES Journal, p214, April, 1967; and Waymouth, “Electric discharge lamps”, the M.I.T. Press, 1971. Electrically conductive metal parts in the lamp mount emit photoelectrons under UV radiation from the arc tube. When these photoelectrons reach the surface of the arc tube, they charge the surface of the quartz negatively, attracting positive sodium ions outward through the quartz wall. The emission of photoelectrons is also dependent on the work function of the metal used in the lamp and the temperature.

Only those electrons that hit the arc tube surface count and have a negative impact on sodium loss. For this reason, metal halide lamp envelopes are usually filled with nitrogen in order to retard the photoelectrons from reaching the arc tube surface. Because the two metal straps around the arc tube directly contact the arc tube surface, nitrogen fill has little effect on retarding the photoelectrons emitted from these two straps. It is very easy for these photoelectrons to reach the arc tube surface, as illustrated in FIGS. 11 and 12. The flux of photoelectrons will hit the arc tube surface on both half cycles. Based on the size and surface area, the photoelectrons emitted from two arc tube straps are a good portion of the total flux.

With fewer photoelectrons produced, sodium diffusion through quartz in the strapless mount structure is significantly slower than that in the structure with straps. The reduced color shift and more stable arc tube chemistry stem from the slower sodium diffusion. When sodium diffusion through the quartz wall takes place, the iodine from sodium iodide remains in the arc tube. This will increase the iodine pressure in the arc tube. High iodine pressure will cause high lamp ignition and reignition voltage problems. Thus, the lamp voltage rise is fast. Moreover, the harmful voltage spikes of mercury iodide could build up during warm-up and normal lamp operation. In the worst case, it would result in lamp cycling.

The test results showed that the metal halide lamps with the strapless structure according to the invention have less voltage rise, less color shift, and better lumen maintenance over life than the lamps with two metal straps. It was determined that the strapless structure reduces photoelectron emissions and thus reduces the driving force for sodium diffusion through the quartz. Elimination of the electrically conductive metal straps is the main contributor to the improved performance. An accelerated life test using a vacuum outer bulb confirmed the reduced sodium diffusion for the strapless structure. The spectrum analysis is consistent with the life test results, which indicates lower iodine pressure, higher sodium pressure, and less shift in scandium to sodium ratio for the strapless structure. It was found that the iodine pressure is closely correlated to lamp voltage rise, and the ratio of the scandium and sodium emissions is somewhat related to lamp voltage rise. Wet chemical analysis also revealed less sodium loss for the strapless mount structure.

Through the use of the vertical or horizontal support clips of the invention, it is possible to achieve the same mechanical strength with the strapless mount of the invention as with the metal support straps of the prior art. In addition, the results of standard vibration tests, drop tests, and shipping tests are equivalent to those obtained with mount structures obtained using the metal support straps of the prior art.

While several embodiments of the invention have been shown, those of ordinary skill in the art will appreciate that other variations are permissible within the scope of the invention as defined by the appended claims. For example, the strapless mount may be used in other types of lamps having press seals such as, for example, tungsten halogen lamps. Other alternatives, variations and modifications will be apparent to those skilled in the art in light of the foregoing description. Accordingly, it is intended to embrace all such alternatives, variations and modifications that fall within the spirit and broad scope of the appended claims.

1. In an electric lamp having a power of about ≧175 W to about 400 W, a light source capsule energizeable for emitting light and including a generally planar seal sealing said capsule in a gas-tight manner, said seal having two generally parallel major faces and two opposing minor faces extending transversely between said major faces, a stem portion and at least one support rod extending adjacent a minor face of said seal,
the improvement wherein said lamp has a strapless mount structure comprising a main frame portion; a first metallic support rod extending from said stem portion and fixed to said main frame portion; a second metallic support rod engaging said dome end of said envelope and fixed to said main frame portion, and a support clip attached at one end to the lower end of the arc tube press, and at a second end to the stem wire or to a frame portion connected to the stem wire or to a portion of the main frame.

2. An electric lamp as claimed in claim 1, wherein the support clip is a vertical clip which at one end is welded to the arc tube lead and restrains the arc tube 10 from lateral, centrifugal, and longitudinal motion.

3. An electric lamp as claimed in claim 2, wherein the vertical clip is attached at a second end to the stem wire.

4. An electric lamp as claimed in claim 1, wherein the support clip is a horizontal clip which at one end slides over the arc tube and firmly restrains the arc tube 10 from lateral, centrifugal, and longitudinal motion.

5. An electric lamp as claimed in claim 4, wherein the horizontal clip is attached at a second end to the a portion of the main frame.

6. An electric lamp as claimed in claim 1, wherein said light source capsule is electrically connected in said lamp in the absence of a field wire.

7. An electric lamp as claimed in claim 1, wherein said strapless mount structure is effective to reduce sodium diffusion in said lamp.

8. An electric lamp as claimed in claim 1, 2 or 4 wherein an insulative covering is present on at least a portion of said main frame.

9. An electric lamp as claimed in claim 1, 2 or 4 wherein said lamp is a high pressure discharge lamp and said light source capsule is a discharge vessel having a press seal at opposing ends thereof, discharge electrodes arranged within said discharge vessel, and a discharge sustaining filling in which a discharge is maintained between said discharge electrodes during lamp operation.

10. A high pressure gas discharge lamp having a power of about >175 W to about 400 W and comprising:
an outer lamp envelope including a lamp stem and an opposing dome end;
a light source arranged generally axially within said outer lamp envelope, said light source including a discharge vessel consisting of a fused silica body and having a
planar press seal at each end thereof, an alkali-halide containing discharge sustaining filling, a pair of discharge electrodes within said discharge vessel body between which an arc discharge is maintained during lamp operation, and conductive lead-throughs extending from each electrode through a respective press, seal to the exterior of said discharge vessel, said press seal having two generally parallel major faces and two opposing minor faces extending between said major faces, said discharge vessel emitting ultraviolet radiation during lamp operation;
wherein said lamp has a strapless mount structure which comprises a main frame portion; a first metallic support rod extending from said lamp stem and fixed to said main frame portion; a second metallic support rod engaging said dome end of said envelope and fixed to said main frame portion; and a support clip attached at one end to the lower end of the arc tube press, and at a second end to the stem wire or to a frame portion connected to the stem wire or to a portion of the main frame.

11. A high pressure gas discharge lamp as claimed in claim 10, wherein said light source is electrically connected in said lamp in the absence of a field wire.

12. A high pressure gas discharge lamp as claimed in claim 11, wherein said strapless mount structure is effective to reduce sodium diffusion in said lamp.

13. A high pressure gas discharge lamp as claimed in claim 10 or 11, wherein an insulative covering is present on at least a portion of said main frame.

14. A strapless mount for a light source of an electric lamp of about ≧175 W to about 400 W, having an outer lamp envelope including a lamp stem and an opposing dome end and a generally planar seal with a pair of generally parallel major faces and a pair of minor faces extending therebetween, said mount comprising a main frame portion; a first metallic support rod extending from said lamp stem and fixed to said main frame portion; a second metallic support rod engaging said dome end of said envelope and fixed to said main frame portion; and a support clip attached at one end to the lower end of the arc tube press, and at a second end to the stem wire or to a frame portion connected to the stem wire or to a portion of the main frame.

15. A strapless mount for a light source of an electric lamp as claimed in claim 14, wherein an insulative covering is present on at least a portion of said main frame.
